(19) United States
(12) Patent Application Publication
(10) Pub. No.: US 2002/0012515 A1
(43) Pub. Date: Jan. 31, 2002

(54) High reliability, fixed attenuator

(76) Inventors: Ernest E. Bergmann, Bethlehem, PA (US); Kimberly A. Miller, Fleetwood, PA (US); Neal H. Thorsten, Lebanon, NJ (US); Harvey L. Wagner, Macungie, PA (US)

Correspondence Address: WILLIAM H. MURRAY, DUANE MORRIS & HECKSCHER LLP, ONE LIBERTY PLACE, PHILADELPHIA, PA, 19103-7396, US

(21) Appl. No.: 09/779,065

(22) Filed: Feb. 8, 2001

Related U.S. Application Data
(60) Provisional application No. 60/200,757, filed on May 1, 2000.

(51) Int. Cl. G02B 6/26; G02B 6/32

(52) U.S. Cl. 385/140; 385/33

(57) ABSTRACT

An optical attenuator includes at least two optical fiber terminations, of which at least one is misaligned, for providing uniform attenuation, which is substantially wavelength independent. At least one of the fiber terminations is misaligned from its position that provides best optical coupling. To accomplish this misalignment, at least one of the fiber terminations is displaced, laterally, longitudinally, or both. This displacement allows only a portion of the incident optical energy to enter an optical fiber core. This reduction in transmission of optical energy provides optical attenuation that is approximately uniform as a function of wavelength. Alternate configurations include at least one lens, such as GRIN lens, a spherical lens, or an aspherical lens, placed between the optical fiber terminations.

### CROSS REFERENCES TO RELATED APPLICATIONS

This nonprovisional U.S. national application, filed under 35 U.S.C. §111(a), claims under 35 U.S.C. §119(e)(1), the benefit of the filing date of provisional U.S. national application Ser. No. 60/200757, filed under 35 U.S.C. §111(b) on May 1, 2000, the teachings of which are incorporated herein by reference.

### FIELD OF THE INVENTION

The present invention relates to optical devices, and specifically to an optical attenuator providing wavelength independent optical attenuation.

### BACKGROUND

In the field of optics, it is often desired to attenuate optical energy uniformly over a specified range of wavelengths. One approach to providing attenuation includes the use of optical filters. Typical optical filters possess wavelength dependent characteristics. Examples include band pass, low pass, and high pass filters. These types of filters are designed to allow transmission of only a portion of the full spectrum of an optical signal. Thus, the optical signal transmitted through the optical filter is attenuated (possesses less optical energy) in comparison to the optical signal supplied to the input of the filter. Disadvantages of using an optical filter to provide attenuation include the fact that producing uniformly attenuating, stable, repeatably manufacturable optical filters is arduous. Another disadvantage is that many optical filters are energy absorbing, and thus are susceptible to thermal damage.

Another approach to providing uniform attenuation is to utilize an air gap as an attenuator. Such an approach is described in U.S. Pat. No. 6,104,856 issued to Lambert, which is hereby incorporated by reference in its entirety. In the approach described therein, spacers are utilized to control the size of the air gap between two optical fibers. Light leaving the end of one fiber spreads gradually within the air gap such that not all of the light enters the core of the other fiber. Thus, the optical signal is attenuated by the loss introduced.

FIG. 1A is a diagram of a pair of connector plugs separated by an air gap to provide attenuation. FIG. 1B is an enlargement of the encircled portion of FIG. 1A, showing more detail. In FIGS. 1A and 1B, optical fibers 4 and 6 are separated by an air gap 10. Light travels from a source (source not shown) through optical fiber 4, through the air gap 10, to optical fiber 6. As light 8 leaves optical fiber 4, it spreads, such that all the light is not received by optical fiber 6. Thus, the light transmitted by optical fiber 6 is attenuated compared to the light transmitted by optical fiber 4.

A disadvantage associated with implementing an air gap to provide uniform attenuation is the creation of strong, unwanted reflected optical energy. Typically, optical fibers are required to be coupled such that the reflected optical energy is below a threshold value. For example, a typical requirement is that reflected light be less than −50 dB. That is, light reflected back into optical fiber 4 is less than −50 dB (relative to the original beam). This requirement may be difficult to achieve with air gap 10 because air gap 10 alone does not attenuate the reflected light sufficiently. It is known in the art to use an indexed matched material between the optical fibers to reduce the amount of light reflected at the fiber-air interfaces (e.g., plastic, quasi-transparent liquid). But, such indexed matched materials do not generally provide uniform attenuation as a function of wavelength. Further, index matching materials may be susceptible to damage through high power operation or by aging.

Another disadvantage of using an air gap, as shown in FIGS. 1A and 1B, to achieve uniform attenuation, is reflected optical energy may interact with the original beam to cause interference. This interference may adversely affect the uniformity of the attenuation, with respect to wavelength, because of partial cancellation and reinforcement of the original beam with the reflected energy. This interference, known as the Fabry-Perot effect, is oscillatory in nature and is a function of spacing and wavelength. The resultant effect is attenuation that oscillates as a function of wavelength.

The inventors have observed, through experimentation, the oscillatory nature of attenuation as a function of wavelength, using the configuration depicted in FIG. 1A. In the experiment, the air gap 10 ranged in length from 1/20 to 1/10 milli-meters. Attenuation ranged from 2.5 dB to 7.5 dB. The peak-to-peak amplitude of the attenuation varied over wavelength by approximately ⅓ dB. Further, as the spacing between the connector tips (air gap 10) was increased, attenuation increased and the Fabry-Perot effects decreased. Thus a need exists for an attenuator which does not suffer the aforementioned disadvantages.

### SUMMARY OF THE INVENTION

An optical attenuator includes at least one misaligned optical fiber termination for providing uniform attenuation, which is substantially wavelength independent. Further, a method for attenuating optical energy approximately uniformly as a function of wavelength, includes intentionally focusing optical energy away from a center core of an optical fiber.

### BRIEF DESCRIPTION OF THE DRAWINGS

The invention is best understood from the following detailed description when read in connection with the accompanying drawing. The various features of the drawings may not be to scale. Included in the drawing are the following figures:

FIG. 1A (Prior Art) is a diagram of a pair of connectors separated by an air gap to provide attenuation;

FIG. 1B (Prior Art) is an enlargement of the encircled portion of FIG. 1A;

FIG. 2 is an illustration of an optical device having two GRIN lenses in accordance with an exemplary embodiment of the present invention;

FIG. 3 is an optical device having a GRIN lens and an aspherical or spherical lens in accordance with another exemplary embodiment of the invention;

FIG. 4 is a diagram of an optical device comprising two spherical or aspherical lenses in accordance with an exemplary embodiment of the invention;

FIG. 5 is a diagram illustrating the positioning of an output fiber termination and a focused optical beam in accordance with an exemplary embodiment of the invention;

FIG. 6 is a diagram illustrating the relative positioning of a focused optical beam and an optical fiber core, in accordance with another exemplary embodiment of the invention;

FIG. 7 is a diagram illustrating the relative positioning of a focused optical beam and an optical fiber core, in accordance with yet another exemplary embodiment of the invention;

FIG. 8 is a diagram illustrating the relative positioning of a focused optical beam and an optical fiber core, in accordance with still another exemplary embodiment of the invention;

FIG. 9 is a diagram of an exemplary optical device exhibiting reciprocal behavior and intentionally misaligned, in accordance with the present invention; and

FIG. 10 is a plot illustrating theoretical, idealized loss in accordance with the present invention.

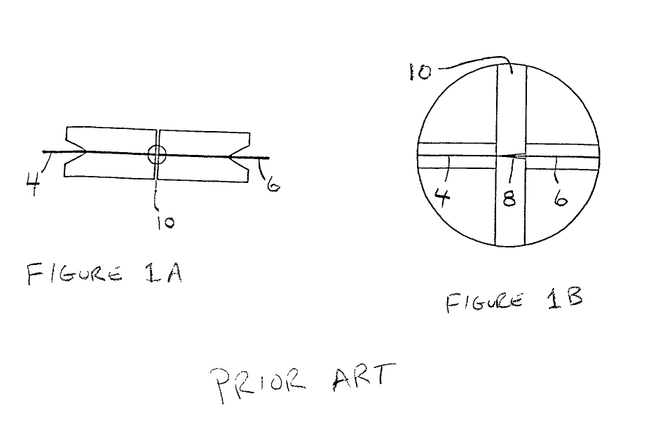

### DETAILED DESCRIPTION

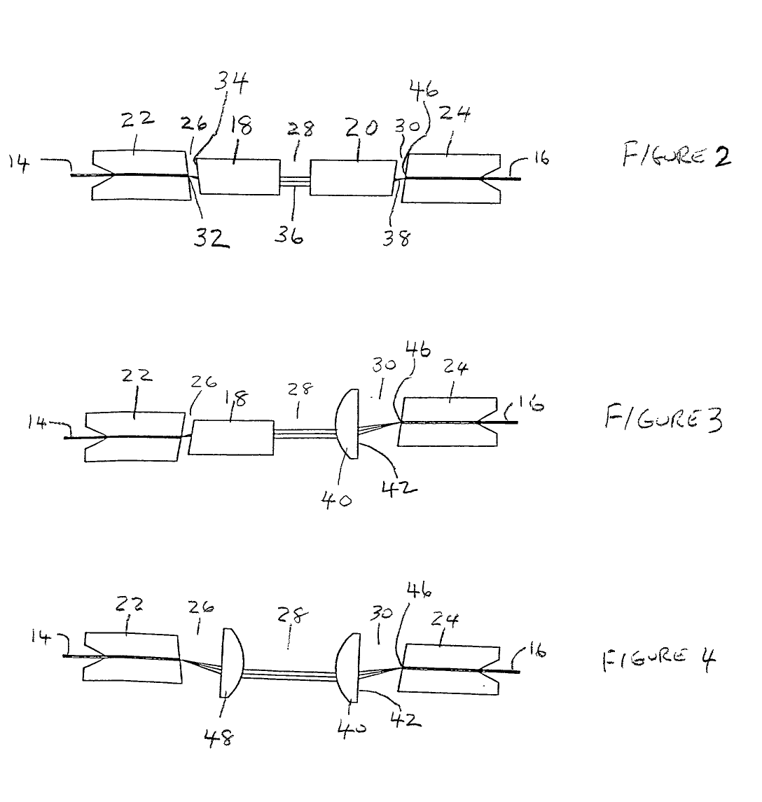

FIG. 2 is an illustration of an optical device having two GRIN lenses in accordance with an exemplary embodiment of the present invention. The device depicted in FIG. 2 comprises input optical fiber 14, output optical fiber 16, input fiber termination 22, output fiber termination 24, input GRIN (gradient index) lens 18, and output GRIN lens 20. Light (optical energy) propagates from a source (source not shown), through optical fiber 14, through an optically transmissive medium 26, through input GRIN lens 18, through an optically transmissive medium 28, through output GRIN lens 20 through an optically transmissive medium 30, to output optical fiber 16. The inventors have discovered that by intentionally misaligning components in this main propagation path, uniform attenuation with respect to wavelength can be reliably achieved. In an exemplary embodiment of the invention, the optically transmissive media 26, 28, and 30 are air. It is envisioned that other combinations of optically transmissive media may be used such as glass, plastic, liquid, and vacuum.

The optical device in FIG. 2 comprises two collimator assemblies. The input collimator assembly comprises input fiber termination 22 and GRIN lens 18, and the output collimator assembly comprises GRIN lens 20 and output fiber termination 24. Collimator assemblies may comprise other types of lenses such as spherical or aspherical lenses. Generally, the purpose of a collimator assembly is to convert light traveling in an optical fiber into an essentially parallel beam of light. Fiber termination 22 is constructed by epoxying the end of optical fiber 14 into a capillary and the end of the fiber is lapped and polished flat within the end of the capillary at an angle (e.g., 8°). This fiber termination is also coated with an anti-reflection (AR) coating to reduce optical energy reflected from the fiber end back into the fiber. Thus, reflected optical energy is reduced and directed away from the main beam path. Typical loss of light observed with this configuration is on the order of only 0.1%, about 0.005 dB. Usually, the end faces of the GRIN lens are also AR coated.

Advantages of implementing a fiber termination are that the termination is easier to grip and manipulate than if the fiber were not terminated, and the ability to reliably position the fiber termination with respect to the lens. The GRIN lens 18 converts the light beam, which diverges from the end of the fiber core 32 into a collimated beam represented by the parallel paths 36. The GRIN lens 18 is AR coated and the surfaces are chosen to minimize coupling of light back into the main beam. That is, surface 34 of GRIN lens 18 is beveled at an angle, which is approximately equivalent to the angle at which the fiber termination 32 is beveled (e.g., 8°).

FIG. 3 is an optical device having a GRIN lens and an aspherical or spherical lens in accordance with another exemplary embodiment of the invention. Light propagates from a source (source not shown), through optical fiber 14, through an optically transmissive medium 26, through input GRIN lens 18, through an optically transmissive medium 28, through output lens 40 through an optically transmissive medium 30, to output optical fiber 16. This exemplary embodiment of the invention may also be used to provide uniform attenuation with respect to wavelength by intentionally misaligning the propagation path. Typically, lens 40 is positioned at a sufficient distance from output fiber end 46 so as not to require side 42 be tilted with respect to fiber end 46. Although, lens 40 may be tilted if desired. Lens 40 and fiber end 46 are AR coated to minimize losses.

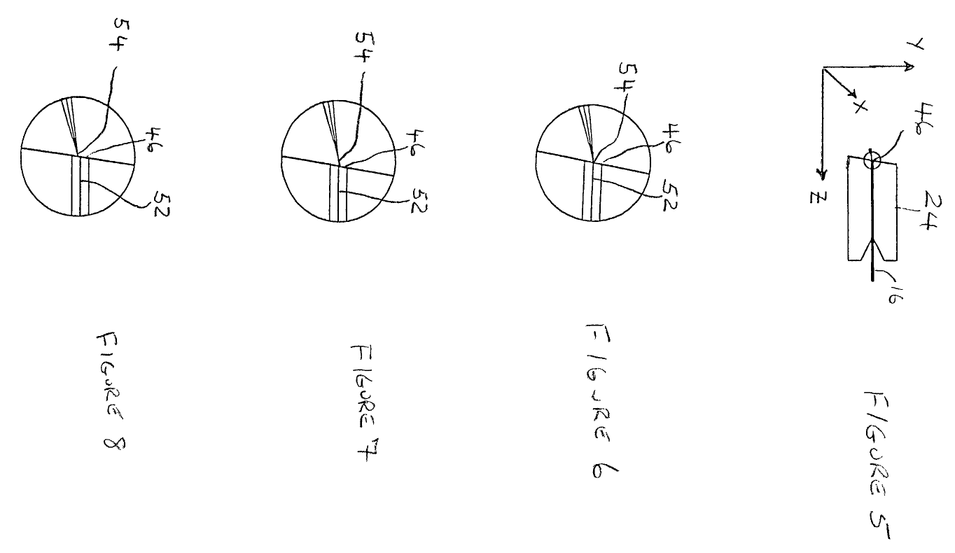

FIG. 4 is a diagram of an optical device comprising two spherical or aspherical lenses in accordance with an exemplary embodiment of the invention. Light propagates from a source (source not shown), through optical fiber 14, through an optically transmissive medium 26, through input lens 48, through an optically transmissive medium 28, through output lens 40 through an optically transmissive medium 30, to output optical fiber 16. This exemplary embodiment of the invention may also be used to provide uniform attenuation with respect to wavelength by intentionally misaligning the propagation path.

FIGS. 2, 3, and 4 illustrate exemplary embodiments of the invention. It is emphasized that these embodiments are exemplary and other embodiments are envisioned. For example, uniform attenuation, which is substantially wavelength independent is attainable by intentionally misaligning optical fiber terminations without implementing lens. The light propagation path may be from the input fiber termination to the output fiber termination. Further, the relative orientation of the bevels of the two fiber terminations is not restricted to the orientation shown in FIGS. 2, 3, and 4. The relative orientation may be in the same plane or different planes. Further, the lens angles may vary slightly and still be in accordance with the present invention. Also the medium between the components may be other than air, a vacuum, glass, or plastic. The medium may be an optically transmissive epoxy. The use of index matching epoxy at a surface may remove the need for an AR coating at that surface.

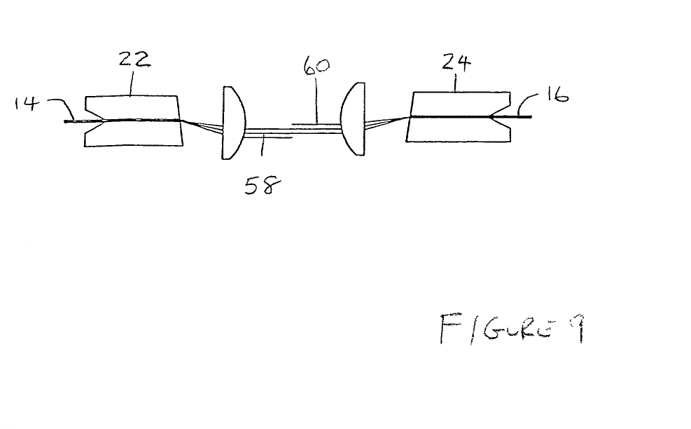

FIG. 5 is a diagram illustrating the positioning of an output fiber termination and an optical beam focal point in accordance with an exemplary embodiment of the invention. In FIG. 5, the Z-axis is parallel to optical fiber 16. The Y-axis is in the same plane as, and perpendicular to the Z-axis. The Y-axis is also in the plane that is normal to the bevel of fiber end 46. The X-axis is perpendicular to both the Y-axis and the Z-axis (e.g., into the paper). The inventors have discovered that uniform attenuation which is substantially wavelength independent is achievable by misaligning components (e.g., lenses and fiber terminations) in the Z direction (i.e., longitudinally), in the plane containing the X-axis and the Y-axis (i.e., laterally), or any combination thereof. The encircled area in FIG. 5 is enlarged in FIGS. 6, 7, and 8 to illustrate the effects of various misalignment techniques in accordance with present invention.

FIG. 6 is a diagram illustrating the relative positioning of a focused optical beam and the core of an optical fiber, in accordance with one exemplary embodiment of the invention. In FIG. 6, the focal point 54 of the optical beam is aligned in the X, Y, and Z axes with the core 52 of output fiber 16. By aligning focal point 54 with core 52 such that they coincide in this manner, approximately all optical energy is coupled to output optical fiber 16.

FIG. 7 is a diagram illustrating the relative positioning of a focused optical beam and an optical fiber core, in accordance with another exemplary embodiment of the invention. In FIG. 7, the focus 54 is moved in the Z-direction away from fiber end 46 (e.g., left). The optical beam starts to expand as it propagates beyond the focus 54, before it reaches fiber end 46. The optical beam center is also shifted laterally (i.e., in the plane containing the X and Y axes), relative to the core center 52 because the direction of the focused beam is canted relative to the Z-direction (i.e., not parallel with the Z-axis). This canting is a consequence of the designed bevel of the fiber termination 46. In an alternate embodiment of the invention, the optical beam is not canted (i.e., the optical beam is parallel with the Z-axis) and the fiber end 46 is beveled. In this alternate embodiment of the invention, the optical beam, upon coupling with the optical fiber 16, refracts off of the fiber axis, resulting in wavelength independent attenuation.

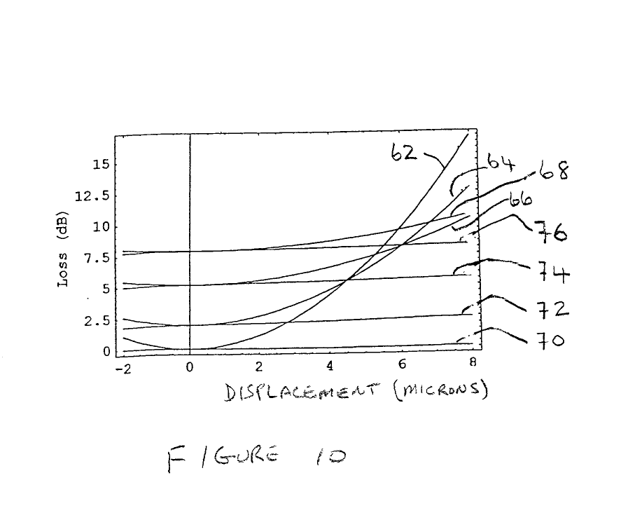

FIG. 8 is a diagram illustrating the relative positioning of a focused optical beam and an optical fiber core, in accordance with yet another exemplary embodiment of the invention. In FIG. 8, focus 54 is moved laterally in the Y-direction away from the position as in FIG. 6 (e.g., downward). Thus, the embodiment shown in FIG. 8 does not utilize spreading of the optical beam to implement wavelength independent attenuation. Instead, this embodiment utilizes lateral misalignment to reduce the coupling of optical energy with output fiber 16. This reduced coupling results in wavelength independent attenuation.

FIG. 9 is a diagram of an exemplary optical device exhibiting reciprocal behavior and intentionally misaligned, in accordance with the present invention. Optical devices may exhibit reciprocal behavior. The coupling losses associated with an optical device exhibiting reciprocal behavior are the same when measured with light traveling from right to left as with light traveling from left to right. Optical devices exhibiting reciprocal behavior typically contain single mode components, and not components such as isolators and circulators. In an optical device exhibiting reciprocal behavior, intentional misalignment may be implemented in the input collimator assembly, the output collimator assembly, or both. As shown in FIG. 9, misalignment is implemented by the relative positioning of the input collimator lens assembly with the output collimator assembly.

For light propagating from left to right, the beam exiting the input collimator assembly is indicated by rays 58. For light propagating from right to left, the light exiting the output collimator assembly is indicated by rays 60. The two collimated beams, 58 and 60, although meeting in the middle and being mutually parallel are laterally offset somewhat one from the other. The misalignment of beams 58 and 60 is related to the relative offset of the input collimator assembly with the output collimator assembly. This offset produces loss of optical energy. The amount of wavelength independent attenuation may be controlled by this offset. The sensitivity of the loss to offset is related to the relative overlap of the cross section of the two beams (58 and 60). Typically, a collimated beam is approximately 50 times larger in diameter than the diameter of the optical fiber. Accordingly, the loss sensitivity to lateral misalignment of the collimated beams is approximately 50 weaker, than the loss sensitivity of misalignment of optical fibers. Thus, the amount of wavelength independent attenuation, may be more accurately controlled by misaligning the collimated beams 58 and 60, than by misaligning the focus 54 and the fiber core center 52.

Other embodiments of the invention include combining intentional misalignment with the functionality provided by various optical elements, for example isolators and filters. Isolators and filters may be constructed with additional components, contained within the interior of the otherwise empty body, for providing intentional optical energy loss by intentional misalignment of the optical energy's propagation path. Other embodiments of the invention include implementing more than two optical fibers. For example, a third optical fiber may be added to a device to support a “tap” function. If the amount of tapped light varies excessively from one device to another, to reduce tap variability, the device may be designed to tap a little too much under conditions of optimum alignment and then, during assembly, misalign the tap port to match the specified tap ratio.

The exemplary embodiments of the invention shown in FIGS. 2, 3, and 4, when not intentionally misaligned to obtain wavelength independent attenuation have experimental end-to-end (fiber-to-fiber) losses typically of 0.3 to 0.5 dB when aligned and welded into permanent configurations. By intentionally misaligning these configurations, additional losses are obtainable. The inventors have conducted experiments, wherein configurations were intentionally misaligned and measurements of excess losses up to 7.5 dB were observed.

Experiments were conducted to show that loss can be reliably added and that the added loss is essentially wavelength independent. A test configuration was fabricated using a laser aligner-welder. The configuration was similar to the configuration shown in FIG. 3. The configuration comprised a collimator assembly with a GRIN lens welded to a one end of a cylindrical, hollow body. To the other end of the body was mounted an aspherical lens and a Z-sleeve. A final fiber termination was attached to the Z-sleeve. Alignment in the Z-axis was in the direction parallel to the center core of the hollow body. Lateral alignment was in the direction of the radius of a cross section of the hollow body. After alignment for minimum attenuation (best coupling) was accomplished, a Hewlett-Packard HP70951B Optical Spectrum Analyzer (OSA) with integral white light source was used to measure the spectral characteristics of the loss. The spectral scans from 1530 to 1570 nm were conducted. A portion of the raw data and tilt are tabulated in Table 1.

TABLE 1

| # | FX (μm) | FY (μm) | FZ (μm) | 1530 (dB) | 1570 (dB) | Tilt |
|---|---|---|---|---|---|---|
| 1 | −790.4 | −554.4 | −2261.0 | −72.23 | −71.95 | 0.28 |
| 2 | −790.4 | −554.4 | −2211.0 | −73.95 | −73.65 | 0.30 |
| 3 | −790.4 | −554.4 | −2161.0 | −75.92 | −75.58 | 0.34 |
| 4 | −790.4 | −554.4 | −2111.0 | −77.55 | −77.30 | 0.25 |
| 5 | −790.4 | −554.4 | −2061.0 | −79.08 | −78.87 | 0.21 |
| 6 | −790.4 | −548.9 | −2261.0 | −74.26 | −73.94 | 0.32 |
| 7 | −790.4 | −546.4 | −2261.0 | −76.87 | −76.51 | 0.36 |
| 8 | −790.4 | −544.4 | −2261.0 | −79.84 | −79.50 | 0.34 |

In Table 1, the first column (#) indicates the test number. The next three columns (FX, FY, and FZ) hold the indicated positions for the indicate the X, Y, and Z directions, respectively, in micrometers (μm). The next column (1530) indicates the observed relative power for a wavelength of 1530 μm, in decibels (dB). The next column (1570) indicates the observed measurement for a wavelength of 1570 μm, in decibels (dB). The last column (tilt) is the absolute value of the difference of the value at 1530 μm minus the value at 1570 μm.

The stage positions and dB readings are not absolute values, rather, they are only to be understood as indicting relative positions and power changes, respectively. Test #1 corresponds to a configuration providing minimal attenuation (best coupling). The output termination was moved in the X, Y, and Z directions as indicated in Table 1 (Note that the output termination was fixed in X position.). As indicated in Table 1, the observed results show an approximately linear rise from the short wavelength side (1530 μm) to the long wavelength side (1570 μm). There was some noise in the instrumental response at higher attenuation levels. Thus, these were averaged over several traces so that the observed peak-to-peak noise was about 0.10 dB. The observed tilt and its variation are attributed to the limitations of the Optical Spectrum Analyzer and the its internal noise. Compensating for these limitations and noise by offsetting the alignment in either Z or Y directions resulted in increased loss with no observable change in tilt within experimental uncertainty.

The inventors have also calculated and plotted theoretical results. FIG. 10 is a plot illustrating theoretical, idealized loss in accordance with the present invention. The plot in FIG. 10, generally designated 100, indicates the theoretical, idealized loss calculated for two Gaussian fiber modes of mode radius of 4.05 μm, typical for the single-mode fiber used, and wavelength 1550 nm for a variety of possible misalignments. Eight curves were plotted and are labeled in plot 100. The curves were plotted using Mathematica® software shown below.

$$\begin{matrix}In [ 1 ] := (* units are in μm *) \\ \begin{matrix}In [ 2 ] := λ = 1.55 \\ w2 = 4.05 ; (* more radius *)\end{matrix} \\ \begin{matrix}In [ 3 ] = k = 2 π / λ ; \\ H [ w1 \_ ] := {( w2 / w1 )}^{2} ; \\ F [ d \_ , w1 \_ ] := 2 d / {kw1}^{2} ; \\ G [ z \_ , w1\_ ] := 2 z / {kw1}^{2} ; \\ K [ z \_ , w1 \_ , d \_ , ψ\_ ] := ( H [ w1 ] + 1 ) {F [ d , w1 ]}^{2} + \\ 2 D [ w1 ] F [ d , w1 ] G [ z , w1 ] sin [ ψ ] + \\ H [ w1 ] ( {G [ z , w1 ]}^{2} + H [ w1 ] + 1 ) {sin [ ψ ]}^{2} ;\end{matrix} \\ B [ z\_ , w1\_ ] := {G [ z , w1 ]}^{2} + {( H [ w1 ] + 1 )}^{2} ; \\ A [ w1\_ ] := \frac{1}{2} {( k w1 )}^{2} ; \\ In [ 8 ] := loss [ z\_ , w1\_ , d\_ , ψ\_ ] := - 10 Log [ 10 , \frac{4 H [ w1 ] Exp - \frac{A [ w1 ] K [ x , w1 , d , ψ ]}{B [ z , w1 ]}}{B [ z , w1 ]} ] ; \\ In [ 9 ] := Plot [ \{ loss [ 0 , w2 , d , 0 ] , loss [ 50 , w2 , d , 0 ] , loss [ 100 , w2 , d , 0 ] , \\ loss [ 150 , w2 , d , 0 ] , loss [ d , w2 , 0 , 0 ] , loss [ 50 + d , w2 , 0 , 0 ] , \\ loss [ 100 + d , w2 , 0 , 0 ] , loss [ 150 + d , w2 , 0 , 0 ] \} , \{ d , - 2 , 8 \} , \\ Frame \to True , Frame Label \to ( “ x displacement ( microns ) ” , “ Loss ( dB ) \} ] ;\end{matrix}$$

Curve 62 represents the ideal loss, in dB, as a function of lateral misalignment from best possible coupling. For curve 64, the optical focal point was moved in the Z direction away from its location in curve 62 (i.e., best coupling) by 50 μm (i.e., the gap between the optical focal point and the fiber end was increased). The ideal loss as a function of lateral misalignment was then plotted. For curve 66, the optical focal point is moved in the Z direction 100 μm from the best coupling position and the ideal loss as a function of lateral misalignment was plotted. For curve 68, the optical focal point is moved in the Z direction 150 μm from the best coupling position and the ideal loss as a function of lateral misalignment was plotted. Curves 70, 72, 74, and 76 represent ideal loss as a function of displacement in the Z direction only. No lateral displacement is introduced. For curves 70, 72, 74, and 76 the starting Z positions of the focal point are the same as curves 62, 64, 66, and 68, respectively.

From plot 100, it can be observed that displacement in the Z direction produces less change in coupling than the same amount of lateral displacement. Thus, finer control of attenuation may be more easily achieved, theoretically, by displacing in the Z direction, than by displacing laterally. Thus, a desired value of attenuation may be obtained (1) by misaligning in the Z direction exclusively, (2) by misaligning in the Z direction first and fine tuning laterally, or (3) by misaligning laterally first and fine tuning in the Z direction. Further, the displacement in the Z direction may be positive or negative. Thus, misalignment may be achieved by moving the fiber and the lens closer together or further apart. However, When moving the fiber and lens closer together, care must be taken not to “crash” the fiber termination into the rear of the lens.

Although illustrated and described herein with reference to certain specific embodiments, the present invention is nevertheless not intended to be limited to the details shown. Rather, various modifications may be made in the details within the scope and range of equivalents of the claims and without departing from the spirit of the invention.

What is claimed is:

1. An optical device comprising a plurality of optical fiber terminations and at least one lens positioned between at least two of said plurality of optical fiber terminations, wherein at least one of (a) at least one of said plurality of optical fiber terminations and (b) at least one of said at least one lens is misaligned for providing uniform attenuation which is substantially wavelength independent.

2. An optical device in accordance with claim 1, wherein at least one of said plurality of optical fiber terminations is displaced laterally for providing uniform attenuation which is substantially wavelength independent.

3. An optical device in accordance with claim 1, wherein at least one of said plurality of optical fiber terminations is displaced longitudinally for providing uniform attenuation which is substantially wavelength independent.

4. An optical device in accordance with claim 1, wherein at least one of said plurality of optical fiber terminations is displaced both longitudinally and laterally for providing uniform attenuation which is substantially wavelength independent.

5. An optical device in accordance with claim 1, wherein at least one of said at least one lens is displaced laterally for providing uniform attenuation which is substantially wavelength independent.

6. An optical device in accordance with claim 1, wherein at least one of said at least one lens is displaced longitudinally for providing uniform attenuation which is substantially wavelength independent.

7. An optical device in accordance with claim 1, wherein at least one of said at least one lens is displaced both longitudinally and laterally for providing uniform attenuation which is substantially wavelength independent.

8. An optical device in accordance with claim 1 further comprising an optically transmissive medium positioned between at least two of said plurality of optical fiber terminations, wherein said optically transmissive medium comprises at least one of air, a vacuum, liquid, glass, and plastic.

9. An optical device in accordance with claim 1, wherein said optical device is one of an isolator and a filter.

10. An optical device in accordance with claim 1, wherein said at least one lens comprises at least one of a gradient index lens, a spherical lens, and an aspherical lens.

11. A method for fabricating an optical device for providing uniform attenuation which is substantially wavelength independent, said optical device comprising a plurality of optical fiber terminations, said method comprising:
laterally misaligning a selected optical fiber termination; and
longitudinally misaligning said selected optical fiber termination.

12. A method in accordance with claim 11 further comprising positioning an optically transmissive medium between at least two of said plurality of optical fiber terminations, wherein said optically transmissive medium comprises at least one of air, a vacuum, liquid, glass, and plastic.

13. A method in accordance with claim 11 further comprising positioning at least one lens between at least two of said plurality of optical fiber terminations.

14. A method in accordance claim 13 further comprising:
laterally misaligning a selected lens; and
longitudinally misaligning said selected lens.

15. A method in accordance with claim 13, wherein said at least one lens comprises at least one of a gradient index lens, a spherical lens, and an aspherical lens.

16. A method for attenuating optical energy approximately uniformly as a function of wavelength, said method comprising:
intentionally focusing said optical energy away from a center core of an optical fiber, wherein a portion of said optical energy is optically coupled to said optical fiber.

17. A method in accordance with claim 16, wherein said focusing comprises displacing said optical energy laterally from said center core.

18. A method in accordance with claim 16, wherein said focusing comprises displacing said optical energy longitudinally from said center core.

19. A method in accordance with claim 16, wherein said focusing comprises displacing said optical energy longitudinally and laterally from said center core.

20. A method in accordance with claim 16, wherein said focusing comprises focusing with a lens.

21. An optical device comprising a plurality of optical fiber terminations, wherein at least one of said plurality of optical fiber terminations is displaced laterally for providing uniform attenuation which is substantially wavelength independent.
